(19) United States
(12) Patent Application Publication
(10) Pub. No.: US 2025/0121224 A1
(43) Pub. Date: Apr. 17, 2025

(54) METHOD AND A SYSTEM FOR PROVIDING FIRE SAFETY OF A CAR PARK

(71) Applicant: Martin Sula, Brno (CZ)

(72) Inventor: Martin Sula, Brno (CZ)

(21) Appl. No.: 18/916,331

(22) Filed: Oct. 15, 2024

(30) Foreign Application Priority Data
Oct. 13, 2023 (CZ) PV 2023-387

(51) Int. Cl. A62C 3/02; A62C 3/07; A62C 37/00

(52) U.S. Cl. CPC A62C 3/0214; A62C 3/07; A62C 37/00

(57) ABSTRACT

The present invention relates to a method of providing fire safety of a car park, comprising the steps of: a. scanning an underside of a vehicle from underneath prior to entering the car park using a first scanning means; b. transmitting scanned data to an evaluation unit; and c. transmitting a command from the evaluation unit to a car park entry control means, and subsequently allowing or denying entry of the scanned vehicle into the car park. In step a., at least one parameter selected from mechanical damage to the underside of the vehicle and temperature of the underside of the vehicle is obtained to generate the scanned data. In step b., the data is compared with reference data and/or previously stored data. Based on said comparison, the evaluation unit determines whether the scanned vehicle is at least partially electrically powered and, subsequently, whether at least one of said parameters exceeds a threshold value for mechanical damage and/or temperature of the underside of the vehicle, thereby generating the command to the car park entry control means. If the scanned vehicle is at least partially electrically powered and the mechanical damage and/or the temperature of the underside of the vehicle is above the threshold value, said command is to deny entry of the scanned vehicle into the car park. If the scanned vehicle has mechanical damage and temperature of the underside of the vehicle below the threshold value, said command is to allow entry of the scanned vehicle into the car park. The present invention further relates to a system for providing fire safety of a car park.

### FIELD OF TECHNOLOGY

The present invention relates to a method and system for providing fire safety of a car park, such as a parking garage, from a battery fire of at least partially electrically powered vehicles.

### BACKGROUND OF THE INVENTION

In recent years, there has been a boom in electric vehicles, and with it the associated disadvantages of risk of battery fires, the risk being with parked EVs and hybrids. For the purpose of the present invention, the term “car park” refers to an area for parking road vehicles, whether open (open car park) or closed (parking garage, parking house, ferry, motorail train, towing service vehicle, etc.).

Japanese patent JP 5345021 B2 discloses a method and a system for temperature scanning of a vehicle prior to entering a car park to distinguish whether the vehicle is an internal combustion engine vehicle or an electric engine vehicle based on an elevated temperature in the exhaust area. The temperature sensor scans the vehicle from the rear underneath of the vehicle. The purpose of this system is to sort vehicles at the entrance so that electric vehicles are directed to available charging stations in the car park.

European patent EP 4049255 B1 discloses a method and a system for controlling a parking space, having a temperature sensor in the floor of a parking space and an evaluation unit recording a temperature profile of a vehicle (over time, on location, compared to a stored previous temperature profile). This determines the type of vehicle (internal combustion engine, electric vehicle, hybrid, etc.) and optionally triggers an imminent fire alarm or warning in case of a temperature rise for battery vehicles. The triggering of an imminent fire alarm or warning may then indicate the blocking of (e.g. a portion of) the car park for other vehicles. The temperature sensor may be a fibre optic or an electronic sensor.

US patent application US2022044023 A1 discloses a method and a system for providing fire safety of a car park. In the first step of the method, an underside of a vehicle is scanned from underneath in a parking garage, or at a charging station, using a scanning means, wherein temperature of the underside of the vehicle is obtained to generate scanned data. In the next step of the method, the scanned data are transmitted to an evaluation unit, wherein the data is compared with reference data and/or previously stored data. Based on said comparison, the evaluation unit determines whether the scanned vehicle is at least partially electrically powered and, subsequently, whether the scanned temperature exceeds a threshold value for temperature of the underside of the vehicle, thereby generating a warning signal providing a warning of a potential fire hazard to a particular person, a monitoring centre or a fire station.

The system according to US 2022044023 A1 comprises: a scanning means positioned in the parking garage, or near a charging station, for scanning the underside of the vehicle from underneath and configured to scan the temperature of the underside of the vehicle; an evaluation unit connected to the scanning means and configured to compare the scanned data from the scanning means with reference data and/or previously stored data and to determine whether the scanned vehicle is at least partially electrically powered and whether the scanned temperature exceeds a threshold temperature for temperature of the underside of the vehicle; and a communication means connected to the evaluation unit and configured to send a warning signal providing a warning of a potential fire hazard (e. g. via Wi-Fi, SMS or Bluetooth).

US patent application US2022366769 A1 discloses a method and an information system for providing fire safety of a car park. In the first step of the method, a vehicle is scanned from the front, and/or from the rear, prior to entry to the car park as well as in a parking space, wherein a vehicle registration number is recorded. In the next step of the method, the scanned data are transmitted to the evaluation unit, wherein the data is compared with reference data and/or previously stored data. Based on said comparison, the evaluation unit determines whether the scanned vehicle is at least partially electrically powered and generates a command to a car park entry control means (e. g. a conventional barrier). The command is a command to allow entry of the scanned vehicle into the car park, and said command is transmitted from the evaluation unit to the car park entry control means. At the same time, the evaluation unit creates data on a data storage in a database of all currently parked vehicles in the car park. The database is available in case of a fire in the car park for fire signalling centre for precise localisation of all parked vehicles in the car park, including the drive types of individual vehicles.

The information system according to US 2022366769 A1 comprises: a scanning means positioned in front of an entrance to the car park and at the parking space for scanning the vehicle from the front or rear, and configured to recognize the vehicle registration number; an evaluation unit connected to the scanning means and configured to compare the scanned data from the scanning means with reference data and/or previously stored data and to determine whether the scanned vehicle is at least partially electrically powered; and a car park entry control means (e. g. a conventional barrier) connected to the evaluation unit and configured to allow entry of the scanned vehicle into the car park. The evaluation unit is further connected to a data storage unit, on which there is a database of all currently parked vehicles in the car park. The database is available in case of a fire in the car park for fire signalling centre for precise localisation of all parked vehicles in the car park, including the drive types of individual vehicles.

US patent application US2009072972 A1 discloses a method and system for authentication of a vehicle. In the first step of the method, the vehicle is scanned from the front and the underside of the vehicle from underneath prior to passing through a check point to a secured zone (e. g. provided with a barrier), by a scanning means, wherein a vehicle registration number is scanned, and an image of the underside is scanned to form scanned data. In the next step of the method, the scanned data is transmitted to an evaluation unit, wherein the data is compared with reference data and/or previously stored data. Based on said comparison, the evaluation unit determines the model of the vehicle, and then whether the underside of the scanned vehicle comprises an anomaly, e. g. an explosive device, a hiding person or smuggled goods, or whether the image of the underside corresponds to the determined vehicle model. In case of detected anomalies on the underside, the evaluation unit generates a command for a means for controlling passage through the check point, wherein the command is to temporarily deny entry of the scanned vehicle. In the third step, the command is transmitted from the evaluation unit to the means for controlling passage through the check point, and the subsequent denial of the entry of the scanned vehicle.

The system according to US 2009072972 A1 includes: a scanning means positioned in front of a passage through a check point for scanning the front of the vehicle and the underside of the vehicle from underneath and configured to scan the vehicle registration number and the underside of the vehicle; an evaluation unit connected to the scanning means and configured to compare the scanned data from the scanning means with reference data and/or previously stored data and to determine the model of the scanned vehicle, and whether the underside of the scanned vehicle comprises an anomaly, e. g. an explosive device, a hiding person or smuggled goods, or whether the image of the underside corresponds to the determined vehicle model; and a means for controlling passage through the check point connected to the evaluation unit and configured to deny passage of the scanned vehicle, if anomaly is detected on the underside of the scanned vehicle.

US Patent Application US2006015398 A1 describes a method and a system for providing safety of a car park from unauthorized access, theft or vandalism, and comprises scanning a passing vehicle through a loop metal sensor.

The patent specifications CN 115142719 A, CN 114592736 A, DE 102021130022 B4, CN 114470563 A, U.S. Pat. No. 9,208,670 A and EP 2686842 B1 disclose a temperature sensor in the floor of a parking space for battery temperature control and fire risk assessment (e.g. during charging), e.g. using a temperature record of an electric vehicle using a thermal imaging camera (infrared, wireless).

The disadvantage of the above systems is that at least partially electrically powered vehicles (i.e. electric cars or hybrids), which are at risk of fire due to mechanical damage to the underside of the vehicle or due to a rise in the temperature of the underside of the vehicle, are allowed to enter the car park and any potential fire is dealt with directly in the car park. Therefore, the risk of fire is not prevented early enough, and despite the temperature monitoring in the parking space, the fire threatens to start inside the car park, where it puts the occupants, other vehicles and the building itself in danger.

In prior art, therefore, there is a need to provide a method and a system for improving fire safety of a car park.

### SUMMARY OF THE INVENTION

It is an object of the invention to provide a method and a system for providing fire safety of a car park that reduces the risk of danger or damage to occupants, other vehicles, and the car park building itself in the event of a fire.

Said object is achieved in the first aspect of the present invention by a method of providing fire safety of a car park, comprising the following steps:
a. scanning an underside of a vehicle from underneath prior to entering the car park using a first scanning means, wherein at least one parameter selected from mechanical damage to the underside of the vehicle and temperature of the underside of the vehicle is obtained to generate scanned data;
b. transmitting the scanned data to an evaluation unit, wherein the data is compared with reference data and/or previously stored data, wherein the evaluation unit determines, based on said comparison, whether the scanned vehicle is at least partially electrically powered and, subsequently, whether at least one of said parameters exceeds a threshold value for mechanical damage and/or temperature of the underside of the vehicle, thereby generating a command to a car park entry control means, wherein if the scanned vehicle is at least partially electrically powered and the mechanical damage and/or the temperature of the underside of the vehicle is above the threshold value, said command is to deny entry of the scanned vehicle into the car park, and wherein if the scanned vehicle has mechanical damage and temperature of the underside of the vehicle below the threshold value, said command is to allow entry of the scanned vehicle into the car park;
c. transmitting said command from the evaluation unit to the car park entry control means, and subsequent allowance or denial of entry of the scanned vehicle into the car park.

The underlying idea of the method according to the present invention lies in that, in the case of a scanned vehicle with at least a partially electric drive, the risk of a battery fire is determined before the vehicle enters the car park, wherein said vehicle is denied entry into the car park in the event of a risk of fire, thereby preventing possible damage to life and property.

Preferably, in step a., data is obtained from the scanned vehicle by means of a communication means on its current operating state, and optionally on its service history, thereby generating additional scanned data. The acquisition of the data by the communication means may take place before, simultaneously with or immediately after the scanning of the underside of the vehicle from underneath by the first scanning means. In step b., a command to deny entry of the scanned vehicle into the car park is modified to a command to allow entry of the scanned vehicle into the car park if, based on the additional scanned data, the operating state of the scanned vehicle is satisfactory from a fire safety perspective. The above modification of steps a. and b. shall ensure that those scanned vehicles are permitted to enter the car park for which fire safety is guaranteed by a workshop or manufacturer despite mechanical damage to the underside of the vehicle or temperature of the underside of the vehicle being above the threshold value.

Preferably, after allowing the scanned, at least partially electrically powered vehicle to enter the car park and after subsequent parking, the underside of the vehicle is scanned from underneath at a parking space by a second scanning means, wherein at least one of said parameters is scanned. The scanned data is transferred to the evaluation unit where it is compared with reference data and/or previously stored data. Based on said comparison, the evaluation unit determines whether at least one of said parameters exceeds the threshold value, thereby generating a command for triggering an imminent fire alarm if said threshold value is exceeded. In this way, vehicles are monitored (continuously or in sections) even after entering the car park, and the imminent risk of fire is detected in time.

Preferably, after triggering the imminent fire alarm, an autonomous parking trolley is inserted under the scanned vehicle, and the scanned vehicle is subsequently lifted and towed by the autonomous parking trolley out of the car park or into a fire-protected area of the car park away from other vehicles. In this way, the risk of fire is reduced by removing its potential source.

Preferably, the threshold value for mechanical damage to the underbody of the vehicle is a bend in the underbody of the vehicle, a hole in the underbody of the vehicle and/or a scratch on the underbody of the vehicle, in particular in a battery area of the at least partially electrically powered vehicle.

Preferably, the threshold value for temperature of the underside of the vehicle is at least 40° C., for example 40° C., 45° C., 50° C., 55° C. or 60° C.

Said object is achieved in the second aspect of the present invention by a system for providing fire safety of a car park, comprising:
a. a first scanning means positioned in front of an entrance to the car park for scanning the underside of the vehicle from underneath and configured to scan at least one parameter selected from mechanical damage to the underside of the vehicle and temperature of the underside of the vehicle;
b. an evaluation unit connected to the first scanning means and configured to compare the scanned data from the first scanning means with reference data and/or previously stored data and to determine whether the scanned vehicle is at least partially electrically powered and whether at least one of said parameters exceeds a threshold value for the mechanical damage and/or temperature of the underside of the vehicle;
c. a car park entry control means connected to the evaluation unit and configured to deny entry of the scanned vehicle into the car park if the scanned vehicle is at least partially electrically powered and has mechanical damage and/or temperature of the underside of the vehicle above said threshold value, and to allow entry of the scanned vehicle into the car park if the scanned vehicle has mechanical damage and temperature of the underside of the vehicle below said threshold value.

The underlying idea of the system according to the present invention lies in that, for a scanned vehicle with at least a partially electric drive, the risk of a battery fire is determined before the vehicle enters the car park, wherein said vehicle is denied entry into the car park in case of a risk of fire, thereby preventing possible damage to life and property.

Preferably, the system further comprises a communication means positioned in front of the entrance to the car park, connected to the evaluation unit and configured to receive data about a current operating state of the scanned vehicle, and optionally about its service history. The communication means may be, for example, an RFID reader, a receiving antenna, a barcode reader, or a QR code reader. It is understood by the skilled person that the communication means may be any component that enables data transmission between the vehicle and said system via a communication protocol.

Preferably, the system further comprises a second scanning means positioned at a parking space for scanning the underside of the vehicle from underneath and configured to scan at least one of said parameters, wherein the evaluation unit is connected to the second scanning means and configured to compare the scanned data from the second scanning means with reference data and/or previously stored data and to determine whether at least one of said parameters exceeds said threshold value. In this way, vehicles are monitored (continuously or in sections) even after entering the car park, and the imminent risk of fire is detected in time.

Preferably, the system further comprises an autonomous parking trolley for inserting itself under the scanned vehicle and lifting and towing it out of the car park or into a fire-protected area of the car park away from other vehicles, if said threshold value is exceeded for at least one of said parameters. In this way, the risk of fire is reduced by removing its potential source.

Preferably, the first and/or second scanning means is a camera, in particular a thermal imaging camera.

Preferably, the car park entry control means is a barrier or a gate.

### BRIEF DESCRIPTION OF THE DRAWINGS

FIG. 1 shows a block diagram of step a. of the method according to the present invention.

FIG. 2 illustrates a block diagram of a service inspection after a recommendation in step c. of the method according to the present invention.

### EXAMPLES

An example embodiment is a method of and a system for providing fire safety of a car park.

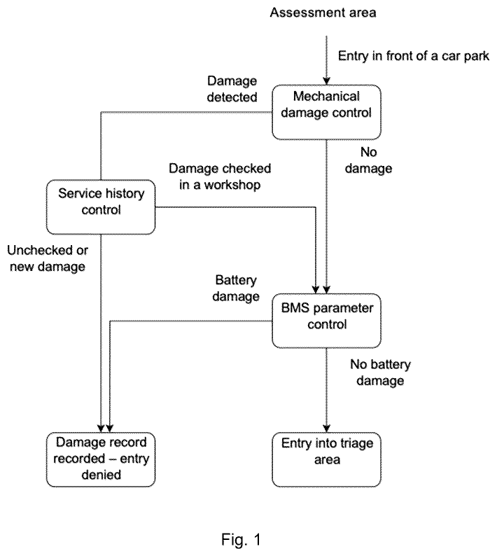

Before a vehicle enters a car park (e.g. a parking garage), the underside of the vehicle is scanned from underneath using a first scanning means in step a. (see FIG. 1). The first scanning means is positioned in front of an entrance into the car park for scanning the underside of the vehicle from underneath and may be, for example, a visible light camera or a thermal imaging camera. In doing so, at least one parameter selected from mechanical damage to the underside of the vehicle and temperature of the underside of the vehicle is scanned to generate scanned data.

In addition, data on the current operating status of the scanned vehicle, and optionally on its service history (e.g. from a logbook and/or a battery management system (BMS)), are acquired from the scanned vehicle via a communication medium, generating additional scanned data (see FIG. 1). The communication means is placed in front of the entrance into the car park and may be, for example, an RFID reader, a receiving antenna, a barcode reader, or a QR code reader. The data acquisition by the communication means takes place before, simultaneously with or immediately after the scanning of the underside of the vehicle from underneath by the first scanning means.

In step b., the scanned data and additional scanned data are transferred to an evaluation unit and compared with reference data and/or previously stored data. Based on said comparison, the evaluation unit determines whether the scanned vehicle is at least partially electrically powered and, subsequently, whether at least one of said parameters exceeds a threshold value for mechanical damage (e.g., a bend in the underside of the vehicle, a hole in the underside of the vehicle, a scratch on the underside of the vehicle) and/or temperature of the underside of the vehicle (e.g., at least 40° C. or at least 50° C.), thereby generating a command for a car park entry control means. If the scanned vehicle is at least partially electrically powered and has mechanical damage and/or temperature of the underside of the scanned vehicle above the threshold value, the command is to deny entry of the scanned vehicle into the car park. If the scanned vehicle has mechanical damage and temperature of the underbody of the scanned vehicle below the threshold value, the command is to allow entry of the scanned vehicle into the car park. If, based on the additional scanned data, the operational condition of the scanned vehicle is satisfactory from a fire safety perspective (i.e. a workshop or manufacturer guarantees operational safety of the battery and/or the damaged underbody of the vehicle), the command to deny entry of the scanned vehicle into the car park is modified to a command to allow entry of the scanned vehicle into the car park.

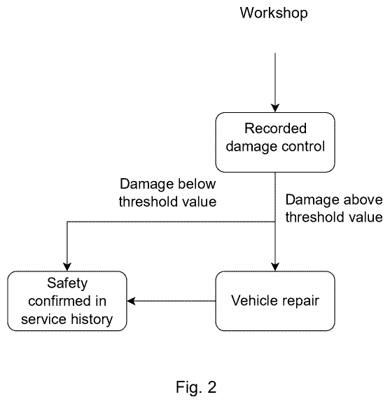

This command is transferred from the evaluation unit to the car park entry control means in step c., and then the scanned vehicle is allowed or denied entry into the car park. The car park entry control means is a barrier or a gate. Optionally, a recommendation to return to the car park after a certain time (e.g., one hour to cool the battery) or a recommendation to visit a workshop is issued with the denial of entry. A workshop visit may end with a damage record in the vehicle's fire safety logbook, so such a vehicle may be allowed to enter the car park (see FIG. 2).

After the scanned vehicle with at least a partially electric drive is allowed to enter the car park and is subsequently parked in a parking space, the underside of the vehicle is scanned from underneath by a second scanning means, wherein at least one of the above parameters is scanned. The second scanning means is positioned in the parking space for scanning the underside of the vehicle from underneath. The scanned data is transferred to the evaluation unit where it is compared with reference data and/or previously stored data. The evaluation unit determines, based on said comparison, whether at least one of said parameters exceeds the threshold value for triggering a command to an imminent fire alarm if the threshold value is exceeded.

After an imminent fire alarm is triggered, an autonomous parking trolley is inserted under the scanned vehicle, and then the scanned vehicle is lifted and towed by the autonomous parking trolley out of the car park or into a fire-protected area of the car park away from other vehicles. The autonomous parking trolley may be electrically powered and May have multiple docking and charging stations within the car park.

### INDUSTRIAL APPLICABILITY

The above-described method and system can be used in parking garages, ferries or motorail trains.

1. A method of providing fire safety of a car park, comprising the steps of:
a. scanning an underside of a vehicle from underneath using a first scanning means, wherein at least one parameter selected from mechanical damage to the underside of the vehicle and temperature of the underside of the vehicle is obtained to generate scanned data;
b. transmitting the scanned data to an evaluation unit, wherein the data is compared with reference data and/or previously stored data, wherein the evaluation unit determines, based on said comparison, whether the scanned vehicle is at least partially electrically powered and, subsequently, whether at least one of said parameters exceeds a threshold value for mechanical damage and/or temperature of the underside of the vehicle,
wherein in step a., the underside of the vehicle is scanned prior to entering the car park, wherein in step b., the evaluation unit subsequently generates a command to a car park entry control means, wherein if the scanned vehicle is at least partially electrically powered and the mechanical damage and/or the temperature of the underside of the vehicle is above the threshold value, said command is to deny entry of the scanned vehicle into the car park, and wherein if the scanned vehicle has mechanical damage and temperature of the underside of the vehicle below the threshold value, said command is to allow entry of the scanned vehicle into the car park;
wherein the method further comprises the step of:
c. transmitting said command from the evaluation unit to the car park entry control means, and subsequent allowance or denial of entry of the scanned vehicle into the car park.

2. The method according to claim 1, wherein in step a., data is obtained from the scanned vehicle by means of a communication means on its current operating state, and optionally on its service history, thereby generating additional scanned data, wherein in step b., a command to deny entry of the scanned vehicle into the car park is modified to a command to allow entry of the scanned vehicle into the car park if, based on the additional scanned data, the operating state of the scanned vehicle is satisfactory from a fire safety perspective.

3. The method according to claim 1, wherein after allowing the scanned, at least partially electrically powered vehicle to enter the car park and after subsequent parking, the underside of the vehicle is scanned from underneath at a parking space by a second scanning means, wherein at least one of said parameters is scanned, wherein the scanned data is transferred to the evaluation unit where it is compared with reference data and/or previously stored data, wherein the evaluation unit determines, based on said comparison, whether at least one of said parameters exceeds the threshold value, thereby generating a command for triggering an imminent fire alarm if said threshold value is exceeded.

4. The method according to claim 3, wherein after triggering the imminent fire alarm, an autonomous parking trolley is inserted under the scanned vehicle, wherein the scanned vehicle is subsequently lifted and towed by the autonomous parking trolley out of the car park or into a fire-protected area of the car park away from other vehicles.

5. The method according to claim 1, wherein the threshold value for mechanical damage to the underbody of the vehicle is a bend in the underbody of the vehicle, a hole in the underbody of the vehicle and/or a scratch on the underbody of the vehicle, in particular in a battery area of the at least partially electrically powered vehicle.

6. The method according to claim 1, wherein the threshold value for temperature of the underside of the vehicle is at least 40° C.

7. A system for providing fire safety of a car park, comprising:
a. a first scanning means for scanning the underside of the vehicle from underneath and configured to scan at least one parameter selected from mechanical damage to the underside of the vehicle and temperature of the underside of the vehicle; and
b. an evaluation unit connected to the first scanning means and configured to compare the scanned data from the first scanning means with reference data and/or previously stored data and to determine whether the scanned vehicle is at least partially electrically powered and whether at least one of said parameters exceeds a threshold value for the mechanical damage and/or temperature of the underside of the vehicle;
wherein the first scanning means is positioned in front of an entrance to the car park, wherein the system further comprises:
c. a car park entry control means connected to the evaluation unit and configured to deny entry of the scanned vehicle into the car park if the scanned vehicle is at least partially electrically powered and has mechanical damage and/or temperature of the underside of the vehicle above said threshold value, and to allow entry of the scanned vehicle into the car park if the scanned vehicle has mechanical damage and temperature of the underside of the vehicle below said threshold value.

8. The system according to claim 7, wherein the system further comprises a communication means positioned in front of the entrance to the car park, connected to the evaluation unit and configured to receive data about a current operating state of the scanned vehicle, and optionally about its service history.

9. The system according to claim 8, wherein the communication means is an RFID reader, a receiving antenna, a barcode reader, or a QR code reader.

10. The system according to claim 7, wherein the system further comprises a second scanning means positioned at a parking space for scanning the underside of the vehicle from underneath and configured to scan at least one of said parameters, wherein the evaluation unit is connected to the second scanning means and configured to compare the scanned data from the second scanning means with reference data and/or previously stored data and to determine whether at least one of said parameters exceeds said threshold value.

11. The system according to claim 7, wherein the system further comprises an autonomous parking trolley for inserting itself under the scanned vehicle and lifting and towing it out of the car park or into a fire-protected area of the car park away from other vehicles, if said threshold value is exceeded for at least one of said parameters.

12. The system according to claim 7, wherein the first and/or second scanning means is a camera, in particular a thermal imaging camera, and in that the car park entry control means is a barrier or a gate.
